(19) United States
(12) Patent Application Publication
(10) Pub. No.: US 2012/0082920 A1
(43) Pub. Date: Apr. 5, 2012

(54) CO-FIRED METAL INTERCONNECT SUPPORTED SOFC

(75) Inventors: Subhasish Mukerjee, Pittsford, NY (US); Karl J. Haltiner, JR., Fairport, NY (US); Rick Daniel Kerr, Fenton, MI (US); Wayne Surdoval, Monroeville, PA (US)

(73) Assignee: DELPHI TECHNOLOGIES INC., TROY, MI (US)

(21) Appl. No.: 12/897,977

(22) Filed: Oct. 5, 2010

(51) Int. Cl. H01M 8/10

(52) U.S. Cl. 429/495; 429/535

(57) ABSTRACT

A method of making a planar solid oxide fuel cell is described involving:
(1) sintering at least an electrolyte layer;
(2) juxtaposing one of a sintered anode or cathode layer with a metal substrate, with a bonding agent therebetween; and
(3) applying heat to bond the juxtaposed anode or cathode layer to the metal substrate;
   where the anode and cathode layers are each sintered, together or independently, simultaneously with sintering the electrolyte layer, simultaneously with applying heat to bond the ceramic fuel cell element to the metal substrate, or in one or more separate sintering steps.

### STATEMENT REGARDING GOVERNMENT SUPPORT

This invention was made with Government support under DE-FC26-02NT41246 awarded by DOE. The Government has certain rights in this invention.

### BACKGROUND OF THE INVENTION

Fuel cells for combining hydrogen and oxygen to produce electricity are well known. One known class of fuel cells is referred to as solid oxide fuel cells (SOFC's). An SOFC generally consists of a cathode and an anode separated by a solid oxide electrolyte. During operation of an SOFC, oxygen is provided to the cathode of the cell while hydrogen-containing fuel is provided to the anode. Oxygen diffuses through the cathode until it reaches the interface of the solid electrolyte where it catalytically converted to oxygen anions with electrons provided by an external circuit connected to the cathode. The solid electrolyte is permeable to the oxygen anions, which diffuse across the electrolyte to the anode where they combine with hydrogen to form water and release electrons, which flow through the external circuit to the cathode, thereby generating electricity.

Another well-known type of fuel cell is referred to as the proton exchange membrane (PEM) fuel cell. Although PEM fuel cells offer many advantages, they suffer from a disadvantage in that proton exchange membrane scheme cannot tolerate carbon monoxide mixed in with the hydrogen fuel. This disadvantage is significant because it means that PEM fuel cells cannot use hydrogen fuel that is provided by hydrocarbon reformers, which produce a reformate fuel containing hydrogen and carbon monoxide. SOFC's, on the other hand, not only tolerate carbon monoxide; they actually utilize the carbon monoxide as fuel by reacting carbon monoxide molecules with oxygen anions to form carbon dioxide, thereby releasing electrons to generate electricity.

Although SOFC's have great potential, the realization of that potential has been limited so far due to a number of factors. SOFC's operate at very high temperatures around 800° C., which places great physical demands on the fuel cell structure, which contributes to cost and design issues with SOFC technology. Four design approaches have been used or proposed to impart physical integrity to the cell structure: (1) electrolyte-supported cell (ESC) structure, (2) anode-supported cell (ASC) structure, (3) cathode-supported cell (CSC) structure, and (4) metal-supported cell (MSC) structure. Each of these approaches has its own advantages and disadvantages. For example, ASC SOFC structures offer generally good performance; however, the high amount of nickel adds to the cost of the fuel cell when the anode layer is made thick enough to provide structural support for the cell, and since the nickel is vulnerable to degradation by oxidation and reduction during operation, the physical integrity of the structure can ultimately be compromised.

MSC structures for solid oxide fuel cell design have generated significant interest because the functional layers of the cell (cathode, electrolyte, and anode) are not subject to design constraints to impart them with the thickness or other physical properties needed to function as a physical support for the cell structure. Prior approaches for making MSC structure SOFC's have often involved spraying or otherwise applying ceramic material (e.g., for the anode, electrolyte, and cathode) onto a metal substrate and then sintering the ceramic materials to form a fuel cell. This approach, however, has difficulty achieving the necessary density for the electrolyte, which generally requires a sintering temperature of at least 1300° C. Such temperatures often cannot be tolerated by many metal substrates such as ferritic steel substrates, which forces a choice between using expensive exotic metal substrates or undesirably low density for the electrolyte. Accordingly, there is a need for MSC structures for SOFC's that do not suffer from the above-described problems.

### SUMMARY OF THE INVENTION

These and other advantages and features will become more apparent from the following description taken in conjunction with the drawings.

Accordingly, in one exemplary non-limiting embodiment of the invention, a method is provided of making a planar solid oxide fuel cell comprising a first electrode layer that is an anode or cathode layer, a second electrode layer that is an anode layer if the first electrode layer is a cathode layer and is a cathode layer if the first electrode layer is an anode layer, and an electrolyte layer between said first electrode layer and said second electrode layer, comprising the steps of:
(1) fabricating an uncured multilayer element comprising the electrolyte layer and the first electrode layer; then
(2) sintering the uncured multilayer element to form a cured multilayer element; and then
(3) juxtaposing the first electrode layer with a metal substrate, with a bonding agent between the first electrode layer and the metal substrate;
(4) applying the second electrode layer to the cured multilayer element such that the electrolyte layer is between the first and second electrode layers; and
(5) applying heat, separately or simultaneously, to sinter the second electrode layer and to bond the first electrode layer to the metal substrate.

In another exemplary non-limiting embodiment of the invention, a method of making a solid oxide fuel cell is provided, comprising the steps of:
(a) providing an anode layer having a first surface and a second surface;
(b) depositing an electrolyte layer onto the first surface of the anode layer;
(c) optionally, depositing a transition layer onto the electrolyte layer;
thereby forming a multilayer structure comprising the layers formed in steps (a), (b), and optionally (c);
(d) sintering the multilayer structure;
(e) depositing a cathode layer onto said transition layer if step (c) was performed, or depositing a cathode layer onto the electrolyte layer or an interlayer and then a cathode layer onto the electrolyte layer if step (c) was not performed;
(f) juxtaposing the second surface of said anode layer to a metal substrate with a bonding agent therebetween; and
(g) applying heat to bond the anode layer to the metal substrate.

In yet another exemplary non-limiting embodiment of the invention, a solid oxide fuel cell is provided comprising a metal support having thereon, in order:

(a) a layer comprising a bonding agent;

(b) an anode layer;

(c) an electrolyte layer;

(d) a transition layer; and

(e) a cathode layer.

The invention provides a robust metal support structure for a solid oxide fuel cell. The SOFC electrolyte that can be sintered at temperatures needed to achieve desired densities. Also, the cathode can be sintered at the same time as the heating of the element to bond the anode to the metal support to provide manufacturing efficiency.

### BRIEF DESCRIPTION OF THE DRAWINGS

The foregoing and other features, and advantages of the invention are described in the following detailed description taken in conjunction with the accompanying drawings in which:

FIG. 1A represents a cross-section view of a green anode, electrolyte, and transition layer of an SOFC disposed on a temporary support.

FIG. 1B represents a cross-section view of an anode, electrolyte, and transition layer of an SOFC after sintering and removal from a temporary support.

FIG. 1C represents a cross-section view of an anode, electrolyte, transition layer, and green cathode of an SOFC juxtaposed and ready for bonding with a metal substrate.

FIG. 1D represents a cross-section view of a sintered anode, electrolyte, transition layer, and cathode of an SOFC bonded to a metal substrate.

### DETAILED DESCRIPTION

Referring now to the Figures, where the invention will be described with reference to specific embodiments, without limiting same.

A number of different paths may be followed in the preparation of a ceramic fuel cell element comprising an anode layer, electrolyte layer, and cathode layer. For example, this three-layer element may be fabricated by conventional ceramic manufacturing techniques as known in the art. Such techniques include, but are not limited to, die pressing, roll compaction, stenciling, screen printing, or ceramic tape casting of layers of green ceramic material.

In general, tape cast layers are formed by depositing a ceramic powder slurry onto a substrate having a release agent on the surface thereof. The slurry can contain conventional components such as a binder (e.g., polyvinyl alcohol or polyvinyl butyral), dispersant (e.g., fish oil), solvent (e.g., ethanol, toluene, methanol, isopropanol), plasticizer, and composite ceramic solids. These materials are milled and sieved to remove soft agglomerates and then dispensed out of a hopper using a doctor blade to distribute and cast the layer onto the substrate. This soft layer is then peeled from the substrate, trimmed to the desired shape and size, and dried to remove the volatiles from the layer, thereby forming a dried green ceramic tape. Multiple layer elements are generally formed by depositing and firing successive tape layers, although in some situations soft tape layers may be deposited or laminated one upon another and then simultaneously sintered or fired.

In one exemplary embodiment, an electrode (either the anode or the cathode) layer is formed from a ceramic tape as described above. Then, an electrolyte layer can be tape cast and deposited onto the soft or dried green ceramic tape electrode layer, or alternatively, a ceramic powder slurry can be screen printed or sprayed onto a dried green ceramic tape electrode layer to form the electrolyte layer. After the electrode layer is sintered, another electrode layer may be applied to the surface of the fired electrolyte layer and sintered to form the ceramic fuel cell element comprising an anode layer, electrolyte layer, and cathode layer.

The materials used for the anode, electrolyte, and cathode layers may be any of the materials known in the art for these layers of an SOFC. Exemplary materials useful for SOFC anodes include composite materials of a ceramic matrix such as yttria-stabilized zirzonia (YSZ) with nickel oxide particles dispersed throughout. NiO in the anode is reduced to Ni typically in-situ by hydrogen flowing through the anode during operation of the stack. Other exemplary SOFC anode materials include copper-ceria composites. Exemplary materials useful for SOFC cathodes include lanthanum-based ceramic compositions (e.g., lanthanum ferrite, lanthanum cobaltite ferrite, lanthanum manganite (“LSM”)) doped with elements such as Sr, Ce, Pr, or Co). In one exemplary embodiment, the cathode material is a mixture of lanthanum (III) oxide, strontium oxide, cobaltite, and ferrite, also known as lanthanum strontium cobaltite ferrite (LSCF). Exemplary materials useful as an SOFC solid electrolyte include YSZ, scandia-stabilized zirconia, and the like.

In one exemplary embodiment, an interlayer such as a doped ceria layer is disposed between the electrolyte and the cathode of the fuel cell element. The interlayer can help prevent harmful interaction between an LSCF cathode and the electrolyte, but is not needed for LSM cathodes. Any conventional technique, as described above (e.g., ceramic screen printing, ceramic tape casting, spraying), may be used to form the interlayer layer.

A tri-layer is formed by depositing a transition layer onto the electrolyte layer of the bi-layer. This transition layer is also known as an interlayer, which will be, in one exemplary embodiment, formed by screen printing a ceramic material onto the surface electrolyte, followed by drying.

A key feature of the invention is the sintering of the electrolyte layer and the first electrode layer prior to attaching the first electrode layer to the metal substrate by applying heat to a bonding agent. Other steps in preparing the fuel cell element, including the depositing and sintering of other layers, may be performed in different orders. For example, an electrolyte layer may be formed by ceramic tape casting techniques, followed by application and drying of ceramic electrode layers to each side of the electrolyte layer. Then, either the anode or cathode layer of this three-layer structure can be juxtaposed with a metal substrate with a bonding agent therebetween, followed by application of heat to simultaneously bond to the metal substrate and sinter the anode and cathode layers. In another exemplary embodiment, a bi-layer of an electrode layer (either the anode or cathode layer) and an electrolyte layer is formed and sintered, after which the other electrode layer is deposited onto the electrolyte layer and dried and the sintered electrode is juxtaposed with the metal substrate with bonding agent therebetween. Heat is then applied to simultaneously bond to the metal substrate and sinter one of the electrodes.

In yet another exemplary embodiment of the method of the invention, a bi-layer having an anode layer and an electrolyte layer or a tri-layer having an anode layer, an electrolyte layer, and a transition layer (also known as an interlayer) is formed by first forming a dried green anode layer, onto which a soft electrolyte tape layer is deposited and then dried. In the case of a tri-layer, the tri-layer is formed by depositing a transition layer (e.g., by screen printing) onto the electrolyte layer of the bi-layer, followed by drying.

The thickness of the deposited SOFC layers are chosen to yield a desired final sintered thickness. In one exemplary embodiment, the final sintered thickness of the anode layer is 5-200 μm, and in another exemplary embodiment is 5-20 μm. In another exemplary embodiment, the final sintered thickness of the electrolyte layer is 5-20 μm. In yet another exemplary embodiment, the final sintered thickness of the cathode layer is 20-50 μm. In a still further exemplary embodiment, the final sintered thickness of an interlayer between the cathode layer and the electrolyte layer is 2-10 μm. The thickness of the metal substrate may vary widely depending on factors such as the design of a stack into which the fuel cell may be incorporated, and in one exemplary embodiment ranges from 100-500 μm.

After preparation of the electrolyte layer, optionally in a multilayer element with one or more other layers of the SOFC, the layer(s) are sintered. In one exemplary embodiment, the layers are sintered at a temperature of at least 1200° C., and at least 1300° C. in another embodiment, and at least 1400° C. in a still further embodiment. High sintering temperatures help to provide a dense electrolyte layer (e.g., at least 95% density, or porosity of less than 5%). This sintering may be conducted in an oven, or heat may be applied through other known means such as microwave, etc.

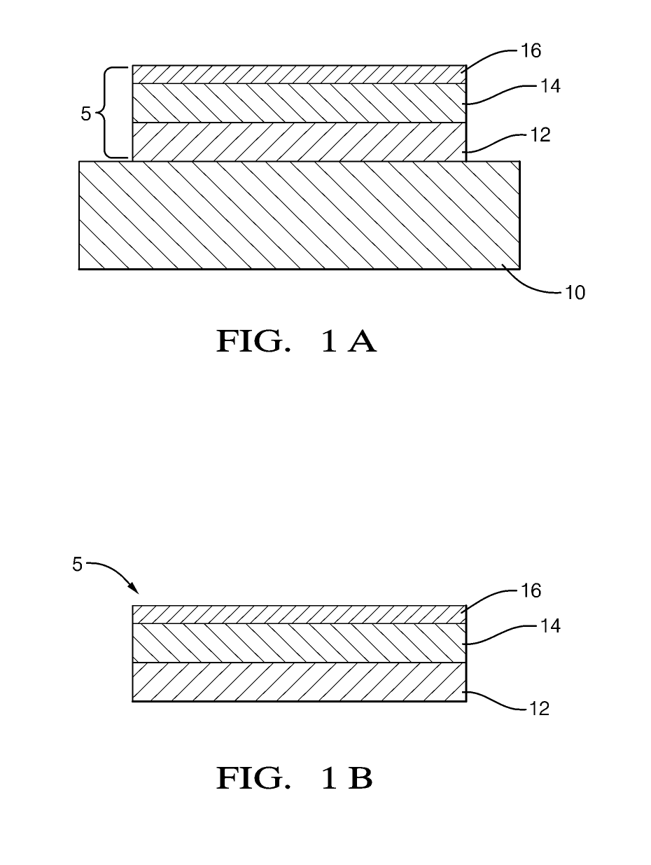

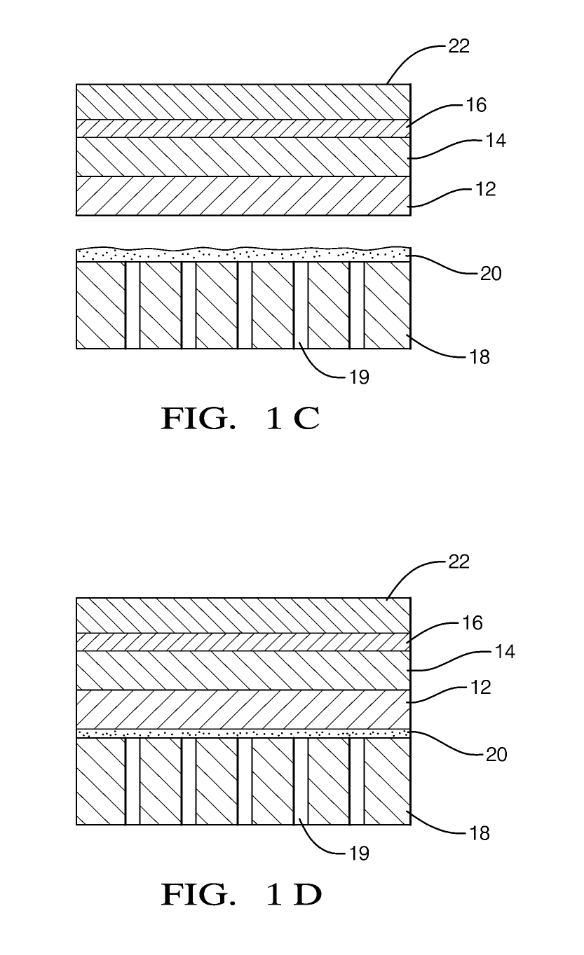

Turning now to the Figures, FIG. 1A shows a dried green multilayer element 5 having an anode layer 12, an electrolyte layer 14, and a transition layer 16 disposed on a temporary substrate 10 for sintering (e.g., at a temperature of at least 1300° C.). The temporary substrate 10 provides physical support to ensure planarity of the resulting sintered element, and may be made of any inert material that will maintain dimensional stability when subjected to the sintering conditions, such as a ceramic (e.g., zirconia, alumina, silicon carbide). After sintering, the multilayer element 5 is removed from the temporary support 10, leaving the multilayer element 5 as shown in FIG. 1B. As shown in FIG. 1C, a green electrode layer 22 is deposited onto the transition layer 16, which may also now be referred to as interlayer 16, and anode layer 12 is juxtaposed with metal substrate 18 with bonding agent 20 disposed therebetween. The sintered layers may be too thin to themselves provide adequate structural strength to the cells during subsequently stack assembly operations or during operation of the stack, so they are bonded to the metal substrate prior to the stack assembly operation.

Metal substrate 18 has openings 19, formed by stamping or other known metal fabricating techniques, therein to allow hydrogen-containing fuel to access anode 12 during operation of the SOFC. It should be noted here that although a slight gap is shown between the bonding agent 20 and the anode layer 12, they will be brought into proximate physical contact during sintering. Heat is then applied at a temperature that can be tolerated by the metal substrate 18, but is sufficient to sinter the cathode layer 22. After heating, the resulting final fuel cell is shown in FIG. 1D having metal substrate 18 with openings 19, having thereon in order an anode layer 12 bonded to the metal substrate with bonding agent 20, electrolyte layer 14, interlayer 16, and cathode layer 22. In an alternate embodiment, the anode-electrolyte bilayer (with optional transition layer) is Ni alloy brazed to the metallic substrate in a reducing environment suitable for conventional brazing. The cathode layer 22 may then be applied and fired to the assembly in an atmospheric where the anode could partially (and harmlessly) re-oxidize.

The metal substrate may comprise any metal that is compatible with the processing conditions and gaseous environment to which the area of the electrodes of the SOFC are exposed during operation. In one exemplary embodiment, the metal support comprises ferritic steel, which provides good dimensional stability at the high temperatures typically experienced during such operation of an SOFC. Because of the corrosive nature of wet reformate on ferritic stainless steels at high temperatures, the ferritic steel may be plated with a corrosion-resistant coating layer as nickel, including Ni plated or Ni clad SS 441, SS 430, or Crofer 22 APU. In order to provide for flow of gas to the electrode (e.g., oxygen to the cathode or fuel to the anode) during operation of the SOFC, the metal substrate in some exemplary embodiments has openings therein, such as stamped openings (e.g., as designated by the reference number 19 in FIGS. 1C and 1D), or is a metal mesh or a metal foam. Also, in certain exemplary embodiments where a fuel cell prepared according to the present invention represents one or more of the repeat fuel cell units in a fuel cell stack, and depending on the design configuration of the stack, the metal substrate serves as an interconnect, providing all or part of an electrically conductive path between adjacent cells in the stack connected in series.

The bonding agent for bonding the ceramic element prepared according to the invention to the metal substrate may be chosen from a number of materials known in the art to be useful for metal-ceramic bonding. In one exemplary embodiment, the bonding agent is metallic such as a metal powder or metal powder slurry or paste that creates a metallurgical bond through known powder metallurgical techniques such as reactive sintering, diffusion bonding, or brazing. Some of these techniques (e.g., diffusion bonding) may require the application of pressure in addition to heat. In one exemplary embodiment, the metallic bonding agent is a nickel-based powder such as Ni braze alloys that can be used in for brazing in reducing environments. If the metallic bonding agent will be exposed to the air during heat-bonding, brazing techniques under an inert atmosphere may need to be used. This would require subsequent steps to place the anode in a reducing or inert atmosphere. Alternatively, to avoid the need for an inert atmosphere, a reactive metal brazing composition may be used, such as a copper-silver reactive air brazing composition as disclosed in U.S. Pat. No. 7,055,733, the disclosure of which is incorporated herein by reference in its entirety. In one exemplary embodiment of the invention, a reactive air brazing composition or ceramic glass bonding agent may be used at the periphery of the electrode surface in an inactive region where the cathode is not applied to the electrolyte opposite the bonded areas, where it would be exposed to air during the heat bonding of the ceramic element to the metal substrate, while another metallic bonding agent (e.g., a nickel bonding paste) may be used in a central portion of the electrode surface. In such an embodiment, the bond may not take effect until the cell is subjected to a reducing atmosphere. In another exemplary embodiment of the invention, the bonding agent is chosen so that the temperature at which bonding is effectuated (generally, the melting point for a metallic bonding agent or a devitrification temperature for a glass ceramic bonding agent) is at or below the temperature that can be tolerated by the metal substrate. In the case of a ferritic steel metal substrate, the bonding temperature is less than or equal to 1000° C., which is normally sufficient to also sinter ceramic layers other than the electrolyte, such as the cathode layer.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A method of making a planar solid oxide fuel cell comprising a first electrode layer that is an anode or cathode layer, a second electrode layer that is an anode layer if the first electrode layer is a cathode layer and is a cathode layer if the first electrode layer is an anode layer, and an electrolyte layer between said first electrode layer and said second electrode layer, comprising the steps of:
(1) fabricating an uncured multilayer element comprising the electrolyte layer and the first electrode layer; then
(2) sintering the uncured multilayer element to form a cured multilayer element; and then
(3) juxtaposing the first electrode layer with a metal substrate, with a bonding agent between the first electrode layer and the metal substrate;
(4) applying the second electrode layer to the cured multilayer element such that the electrolyte layer is between the first and second electrode layers; and
(5) applying heat, separately or simultaneously, to sinter the second electrode layer and to bond the first electrode layer to the metal substrate.

2. A method according to claim 1 wherein the metal substrate comprises ferritic steel.

3. A method according to claim 2 wherein the metal substrate is nickel plated.

4. A method according to claim 2 wherein the electrolyte layer is sintered at a temperature of at least 1200° C. and step (3) is performed at a temperature at most 1000° C.

5. A method according to claim 1 wherein the electrolyte layer is sintered at a temperature of at least 1200° C.

6. A method according to claim 1 wherein the bonding agent is a metal bonding composition selected from the group consisting of a braze alloy, a reactive air braze alloy, and a diffusion bonding material, or a glass ceramic bonding composition, or combinations thereof.

7. A method according to claim 6 wherein the metal bonding composition is a brazing composition.

8. A method according to claim 7 wherein the brazing composition is a reactive air brazing composition.

9. A method according to claim 6 wherein the bonding agent comprises a nickel metal bonding composition in a central region of the fuel cell and a reactive air brazing composition or a glass ceramic bonding composition at the periphery of the fuel cell.

10. A method according to claim 1, further comprising the step of incorporating the fuel cell as a fuel cell unit in a fuel cell stack of repeating fuel cell units, wherein the metal substrate also functions as an electrical interconnect to an adjacent fuel cell unit.

11. A method according to claim 1 wherein the anode layer has a thickness after sintering of 5-200 μm.

12. A method according to claim 10 wherein, after sintering, the electrolyte layer has a thickness after sintering of 5-20 μm, the transition layer has a thickness of 2-10 μm, the cathode has a thickness of 20-50 μm, and the metal substrate has a thickness of 100-500 μm.

13. A method according to claim 1 wherein the metal substrate has openings to allow for the diffusion of fuel into the anode during operation of the fuel cell.

14. A method according to claim 1 wherein the first electrode layer is an anode layer and the second electrode layer is a cathode layer.

15. A method according to claim 1 wherein:
(i) the cathode layer comprises lanthanum, strontium, cobalt, and ferrite;
(ii) the transition layer comprises ceria;
(iii) the electrolyte layer comprises zirconia stabilized with yttria; and
(iv) the anode layer comprises nickel oxide and yttria-stabilized zirconia.

16. A method according to claim 1, comprising the steps of:
(a) providing an anode layer having a first surface and a second surface;
(b) depositing an electrolyte layer onto the first surface of the anode layer;
(c) optionally, depositing a transition layer onto the electrolyte layer;
thereby forming a multilayer structure comprising the layers formed in steps (a), (b), and optionally (c);
(d) sintering said multilayer structure;
(e) depositing a cathode layer onto said transition layer if step (c) was performed, or depositing a cathode layer or an interlayer and then a cathode layer onto the electrolyte layer if step (c) was not performed;
(f) juxtaposing the second surface of said anode layer to a metal substrate with a bonding agent therebetween; and
(g) applying heat to bond the anode layer to the metal substrate.

17. A method according to claim 16 wherein the heat applied in step (g) sinters the cathode layer in addition to bonding the anode layer to the metal substrate.

18. A method according to claim 16 wherein the bonding agent is a metal bonding composition selected from the group consisting of a braze alloy, a reactive air braze alloy, and a diffusion bonding material, or a glass ceramic bonding composition, or combinations thereof.

19. A method according to claim 18 wherein the metal bonding composition is a brazing composition.

20. A method according to claim 19 wherein the brazing composition is a reactive air brazing composition.

21. A method according to claim 18 wherein the bonding agent comprises a nickel metal bonding composition in a central region of the fuel cell and a reactive air brazing composition comprising or a glass ceramic bonding composition at the periphery of the fuel cell.

22. A solid oxide fuel cell comprising a metal support having thereon, in order:
(a) a layer comprising a bonding agent;
(b) an anode layer;
(c) an electrolyte layer;
(d) a transition layer; and
(e) a cathode layer.
